(19) United States
(12) Patent Application Publication
(10) Pub. No.: US 2024/0166870 A1
(43) Pub. Date: May 23, 2024

(54) ISOCYANATE-AMINE-BASED CHEMICAL ANCHOR WITH IMPROVED PERFORMANCE, AND USE THEREOF

(71) Applicant: Hilti Aktiengesellschaft, Schaan (LI)

(72) Inventors: Memet-Emin Kumru, Augsburg (DE); Christian Plenk, Kaufering (DE); Thomas Bürgel, Landsberg (DE)

(73) Assignee: Hilti Aktiengesellschaft, Schaan (LI)

(21) Appl. No.: 18/550,385

(22) PCT Filed: Mar. 4, 2022
(86) PCT No.: PCT/EP2022/055589

§ 371 Date: Sep. 13, 2023

(30) Foreign Application Priority Data
Mar. 16, 2021 (EP) 21162925.8

(51) Int. Cl. C08L 75/12; C04B 24/28; C08G 18/28; C08G 18/38; C08G 18/79; C08K 3/36; C09J 175/12; C09K 8/44; E04B 1/38

(52) U.S. Cl. CPC C08L 75/12; C04B 24/282; C08G 18/289; C08G 18/3868; C08G 18/792; C08K 3/36; C09J 175/12; C09K 8/44; E04B 1/38

(57) ABSTRACT

A multi-component resin system can be used for producing a mortar composition based on isocyanate amine adducts for the chemical fastening of construction elements. A mortar composition based on isocyanate amine adducts can be produced from the multi-component resin system. The mortar composition based on the isocyanate amine adducts is useful for the chemical fastening of construction elements in mineral substrates.

The present invention relates to a multi-component resin system for producing a mortar composition based on isocyanate amine adducts for the chemical fastening of construction elements. The invention also includes a mortar composition based on isocyanate amine adducts produced from the multi-component resin system. The present invention also relates to a method for the chemical fastening of construction elements in mineral substrates and to the use of a mortar composition based on the isocyanate amine adducts for the chemical fastening of construction elements in mineral substrates.

In order to securely fasten components such as threaded anchor rods, reinforcing bars, threaded sleeves and screws in a mineral substrate such as concrete, natural stone or plaster, the boreholes for receiving the components to be fastened are first drilled into the mineral substrate with the appropriate dimensions. The boreholes are then cleared of drilling dust and the two component mortar composition is introduced into the borehole after mixing the resin component with the hardener component. The component to be fastened is then inserted into the borehole filled with the mortar composition and adjusted. After the mortar composition has cured by reaction of the resin component with the hardener component, the component is firmly held in the mineral substrate.

The load-bearing behavior of the components fastened in this way depends on several influencing variables, which are usually classified as internal and external variables. The internal influencing variables include the chemical composition of the mortar composition, the production process thereof and the packaging of the mortar composition, which typically comprises components present in two separate containers.

The external influencing variables include the type of borehole cleaning, the quality of the mineral substrate, for example the concrete, its humidity and temperature, and the type of borehole production.

It is also known that the mechanical properties of the cured mortar composition are significantly influenced by the quality of the borehole cleaning and the moisture in the mineral substrate. In damp boreholes and/or boreholes that have been only poorly cleaned of drilling dust, there is a considerable decrease in performance, which is reflected in the reduced load values of the cured mortar composition.

In addition to developing and improving the existing binder systems, efforts are therefore also being made to examine binder systems other than those mentioned above with regard to their suitability as a basis for mortar compositions for chemical fastening. For example, EP 3 447 078 A1 describes a chemical anchor which is produced from a multi-component composition which comprises a polyisocyanate component and a polyaspartic acid ester component. When the two components are mixed, polyurea is formed in a polyaddition reaction, which forms the binder of the mortar composition.

WO 2011/113533 A1 relates to a fastening mortar system used for mortar fixation of anchoring means and based on one or more epoxy-base curable reactive resins in holes or gaps, the system containing one or more silanes, which optionally have reactive groups capable of participating in the polymerization with the epoxy-base reactive resin and in any case silicon-bonded hydrolyzable groups. Halogen, ketoximate, amino, aminoxy, mercapto, acyloxy, aryloxy, aralkyloxy and, in particular, alkyloxy groups are used as silicon-bonded hydrolyzable groups in the one or more silanes.

DE 10 2015 109 125 A1 rotates to a curing agent composition for a synthetic mortar system that is curable by addition polymerization used for mortar fixation of anchoring means in holes or gaps, the curing agent composition containing oligomeric siloxanes which have on average at least one organic group per molecule. The organic group carries one or more secondary and/or primary amino and/or thiol groups which are reactive in the addition reaction with isocyanate or epoxy groups. The siloxanes also have one or more hydrolyzable silicon-bonded groups. The curing agent composition can also contain one or more further conventional additives.

These mortar compositions, which are known from the prior art, already show an improvement in the load values in wet boreholes, but hardly at all in dry boreholes. However, production of the silane and siloxane additives used in the prior art is complex and expensive. Furthermore, monomeric silanes with hydrolyzable and in particular silicon-bonded groups have the disadvantage that they release enormous amounts of volatile organic compounds (VOCs), for example alcohols, in hydrolysis during use and are complicated and expensive to produce.

In relation to the prior art, there is therefore a need for two-component mortar compositions with good adhesion in dry boreholes, in particular in well-cleaned boreholes, which are easy to process and contain additives which are simple to produce and inexpensive.

The object of the invention is achieved by providing a multi-component resin system according to claim 1. Preferred embodiments of the multi-component resin system according to the invention are provided in the dependent claims, which may optionally be combined with one another.

The invention also relates to a mortar composition according to claim 23 which is intended for the chemical fastening of construction elements and is produced from the multi-component resin system according to the invention.

The invention also relates to a method according to claim 24 for the chemical fastening of construction elements in mineral substrates and to the use of the multi-component resin system according to the invention or the mortar composition produced therefrom according to claim 25 for the chemical fastening of construction elements in mineral substrates.

The invention firstly relates to a multi-component resin system containing an isocyanate component which comprises at least one aliphatic and/or aromatic polyisocyanate having an average NCO functionality of 2 or more, and an amine component which comprises at least one amine which is reactive to isocyanate groups and has an average NH functionality of 2 or more, with the proviso that the multi-component resin system is free of polyaspartic acid esters, the isocyanate component and/or the amine component comprising at least one filer and at least one rheology additive and the total filling level of a mortar composition produced by mixing the isocyanate component and the amine component being in a range from 30 to 80%, characterized in that the isocyanate component and/or the amine component contains at least one additive, the additive being
a compound of formula I

Aₙ(L)ₘ(X)ₚ (formula I),
where
   A is phosphorous, boron, aluminum, titanium or zirconium,
   X can be the same or different and is an alkoxy, aryloxy or acyloxy group,
   L can be the same or different and is at least one ligand.
   n is the valency of A, and
   p is an integer from 1 to n.
   m is 0 or an integer from 1 to n−1 and
   n=m+p,
or
a siloxane having at least one functional group which is capable of addition reaction to isocyanates, but which has no hydrolyzable groups bonded to a silicon atom.

It has surprisingly been found that the use of the organometallic compounds of formula I or of siloxanes as additives in isocyanate-amine-based chemical anchors increases the bond stresses in dry concrete in the same way as silanes with hydrolyzable groups bonded to a silicon atom.

It is also essential to the invention that the multi-component resin system and in particular the amine component of the multi-component resin system be free of polyaspartic acid esters. The expression “free of polyaspartic acid esters” in the context of the present application means that the proportion of polyaspartic acid esters in the multi-component resin system is preferably less than 2 wt. %, more preferably less than 0.5 wt. % and even more preferably less than 0.1 wt. %, based in each case on the total weight of the multi-component resin system. The presence of polyaspartic acid esters in the aforementioned weight percentage ranges can be attributed to potential impurities. The proportion of polyaspartic acid esters in the mufti-component resin system is, however, particularly preferably 0.0 wt. %, based on the total weight of the multi-component resin system.

For better understanding of the invention, the following explanations of the terminology used herein are considered to be useful. Within the meaning of the invention:
A “multi-component resin system” is a reaction resin system that comprises a plurality of components stored separately from one another, generally a resin component and a hardener component, so that curing takes place only after all components have been mixed.
“isocyanates” are compounds that have a functional isocyanate group —N═C═O and are characterized by the structural unit R—N═C═O.
“Polyisocyanates” are compounds that have at least two functional isocyanate groups —N═C═O; diisocyanates, which are also covered by the definition of polyisocyanate, are characterized, for example, by the structure O═C═N—R—N═C═O and thus have an NCO functionality of 2.
“Average NCO functionality” describes the number of isocyanate groups in the compound; in the case of a mixture of isocyanates, the “averaged NCO functionality” describes the averaged number of isocyanate groups in the mixture and is calculated according to the formula: averaged NCO functionality (mixture)=Σaverage NCO functionality (isocyanate i)/nᵢ, i.e. the sum of the average NCO functionality of the individual components divided by the number of individual components.
“Isocyanate component” or also A component describes a component of the multi-component resin system which comprises at least one polyisocyanate and optionally at least one filler and/or at least one rheology additive and/or further additives.
“Amines” are compounds which have a functional NH group, are derived from ammonia by replacing one or two hydrogen atoms with hydrocarbon groups and have the general structures RNH₂ (primary amines) and R₂NH (secondary amines) (see: IUPAC Compendium of Chemical Terminology, 2nd ed. (the “Gold Book”), compiled by A. D. McNaught and A. Wilkinson, Blackwell Scientific Publications, Oxford (1997)). The compound class of polyaspartic acid esters is explicitly excluded from the term amines in the context of the present inventions. These are defined separately under the term polyaspartic acid esters.
“NH functionality” describes the number of active hydrogen atoms that can react with an isocyanate group in an amino group.
“Average NH functionality” describes the number of active hydrogen atoms that can react with an isocyanate group in an amine and results from the number and NH functionality of the amino groups contained in the compound, i.e. the amine; in the case of a mixture of amines, the “averaged NH functionality” describes the averaged number of active hydrogen atoms in the mixture and is calculated according to the formula: averaged NH functionality (mixture)=Σaverage NH functionality (amine i)/nᵢ, i.e. the sum of the average NH functionality of the individual components divided by the number of individual components.
The term “polyaspartic acid esters” refers to compounds of the general formula:

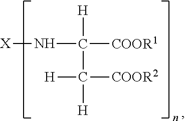

in which
   R¹ and R² can be the same or different and represent an organic group which is inert to isocyanate groups,
   X represents an n-valent organic group which is inert to isocyanate groups, and
   n represents an integer of at least 2, preferably from 2 to 6, more preferably from 2 to 4 and particularly preferably 2.
“Amine component” or also 8 component describes a component of the multi-component resin system which comprises at least one amine and optionally at least one filler and/or at least one rheology additive and/or further additives.
“Isocyanate amine adducts” are polymers that are formed by the polyaddition reaction of isocyanates with amines. The isocyanate amine adducts according to the invention are preferably polyureas which comprise at least one structural element of the form-[—NH—R—NH—NH—R′—NH—].
“Aliphatic compounds” are acyclic or cyclic, saturated or unsaturated carbon compounds, excluding aromatic compounds.
“Alicylic compounds” are compounds having a carbocyclic ring structure, excluding benzene derivatives or other aromatic systems.
“Araliphatic compounds” are aliphatic compounds having an aromatic backbone such that, in the case of a functionized araliphatic compound, a functional group that is present is bonded to the aliphatic rather than the aromatic part of the compound.
“Arometic compounds” are compounds which follow Hückel's rule (4n+2).
A “two-component reaction resin system” means a reaction resin system that comprises two separately stored components, in the present case an isocyanate component and an amine component, so that curing takes place only after the two components have been mixed.
The term “mortar composition” refers to the composition that is obtained by mixing the isocyanate component and the amine component and as such can be used directly for chemical fastening.
The term “filler” refers to an organic or inorganic, in particular inorganic, compound
The term “rheology additive” refers to additives which are able to influence the viscosity behavior of the isocyanate component, the amine component and the multi-component resin system during storage, application and/or curing. The rheology additive prevents, inter alia, sedimentation of the fillers in the polyisocyanate component and/or the amine component. It also improves the miscibility of the components and prevents possible phase separation.
The term “temperature resistance” refers to the change in the bond stress of a cured mortar composition at an elevated temperature compared with the reference bond stress. In the context of the present invention, the temperature resistance is specified in particular as the ratio of the bond stress at 80° C., to the reference stress,
“A” or “an” as the article preceding a class of chemical compounds, e.g. preceding the word “filler,” means that one or more compounds included in this class of chemical compounds, e.g. various “fillers,” may be intended.
“At least one” means numerically “one or more”; in a preferred embodiment, the term means numerically “one.”
“Contain” and “comprise” mean that more constituents may be present in addition to the mentioned constituents; these terms are meant to be inclusive and therefore also include “consist of”: “consist of” is meant exclusively and means that no further constituents may be present; in a preferred embodiment, the terms “contain” and “comprise” mean the term “consist of.”

All standards cited in this text (e.g. DIN standards) were used in the version that was current on the filing date of this application.

Isocyanate Compounds

The multi-component resin system according to the invention comprises at least one isocyanate component and at least one amine component. Before use, the isocyanate component and the amine component are provided separately from one another in a reaction-inhibiting manner.

The isocyanate component comprises at least one polyisocyanate. All aliphatic and/or aromatic isocyanates known to a person skilled in the art and having an average NCO functionality of 2 or more, individually or in any mixtures with one another, can be used as the polyisocyanate. The average NCO functionality indicates how many NCO groups are present in the polyisocyanate. Polyisocyanate means that two or more NCO groups are contained in the compound.

Suitable aromatic polyisocyanates are those having aromatically bound isocyanate groups, such as diisocyanatobenzenes, toluene diisocyanates, diphenyl diisocyanates, diphenylmethane diisocyanates, diisocyanatonaphathalenes, triphenylmethane triisocyanates, but also those having isocyanate groups that are bound to an aromatic group via an alkylene group, such as a methylene group, such as bis- and tris-(isocyanatoalkyl)benzenes, toluenes and xylenes.

Preferred examples of aromatic polyisocyanates are: 1,3-phenylene diisocyanate, 1,4-phenylene diisocyanate, 2,4-toluylene diisocyanate, 2,5-toluylene diisocyanate, 2,6-toluylene diisocyanate, 1,3-xylylene diisocyanate, 1,4-xylylene diisocyanate, tetramethyl-1,3-xylylene diisocyanate, tetramethyl-1,4-xylylene diisocyanate, 1,3-bis(isocyanatomethyl)benzene, 1,4-bis(isocyanatomethyl)benzene, ethylphenyl diisocyanate, 2-dodecyl-1,3-phenylene diisocyanate, 2,4,6-triisopropyl-m-phenylene diisocyanate, 2,4,6-trimethyl-1,3-phenylene diisocyanate, xylylene diisocyanate, 1,5-naphthylene diisocyanate, 3,3′dimethyl-4,4′-biphenyl diisocyanate, 3,3′-dimethoxy-4,4′-biphenyl diisocyanate, 3,3′-dimethyl-4,4′-biphenyl diisocyanate, diphenylene methane-2,4′-diisocyanate, diphenylene methane-2,2-diisocyanate, diphenylene methane-4,4′-diisocyanate, triphenylmethane-4,4′,4″-triisocyanate, 5-(p-isocyanatobenzyl)-2-methyl-m-phenylene diisocyanate, 4,4-diisocyanato-3,3,5,5-tetraethyldiphenylmethane, 5,5′-ureylene di-o-tolyl diisocyanate, 4-[(5-isocyanato-2-methylphenyl)methyl)-m-phenylene diisocyanate, 4-[(3-isocyanato-4-methylphenyl)methyl]-m-phenylene diisocyanate, 2,2′-methylene-bis(6-(o-isocyanatobenzyl)phenyl]diisocyanate.

Aliphatic isocyanates which have a carbon backbone (without the NCO groups contained) of 3 to 30 carbon atoms, preferably 4 to 20 carbon atoms, are preferably used. Examples of aliphatic polyisocyanates are bis(isocyanatoalkyl) ethers or alkane diisocyanates such as methane diisocyanate, propane diisocyanates, butane diisocyanates, pentane diisocyanates, hexane diisocyanates (e.g. hexamethylene diisocyanate, HDI), heptane diisocyanates (e.g. 2,2-dimethylpentane-1,5-diisocyanate, octane diisocyanates, nonane diisocyanates (e.g. trimethyl HDI (TMDI) usually as a mixture of the 2,4,4- and 2,2,4-isomers), 2-methylpentane-1,5-diisocyanate (MPDI), nonane triisocyanates (e.g. 4-isocyanatomethyl-1,8-octane diisocyanate, 5-methylnonane diisocyanate), decane diisocyanates, decane triisocyanates, undecane diisocyanates, undecane triisocyanates, dodecane diisocyanates, dodecane triisocyanates, 1,3- and 1,4-bis-(isocyanatomethyl)cyclohexane (H₆XDI), 3-isocyanatomethyl-3,5,5-trimethylcyclohexyl isocyanate (isophorone diisocyanate, IPDI), bis-(4-isocyanatocyclohexyl)methane (H₁₂MDI), bis-(isocyanatomethyl)norbornane (NBDI) or 3(4)-isocyanatomethyl-1-methyl-cyclohexyl isocyanate (IMCI), octagydro-4,7-methano-1H-indenedimethyl diisocyanate, norbornene diisocyanate, 5-isocyanato-1-(isocyanatomethyl)-1,3,3-trimethylcyclohexane, ureylene-bis(p-phenylenemethylene-p-phenylene)diisocyanate.

Particularly preferred isocyanates are hexamethylene diisocyanate (HDI), trimethyl HDI (TMDI), pentane diisocyanate (PDI), 2-methylpentane-1,5-diisocyanate (MPDI), isophorone diisocyanate (IPDI), 1,3- and 1,4-bis-(isocyanatomethyl)cyclohexane (H₆XDI), bis-(isocyanatomethyl)norbornane (NBDI), 3(4)-isocyanatomethyl-1-methyl-cyclohexyl isocyanate (IMCI) and/or 4,4′bis(isocyanatocyclohexyl)methane (H₁₂MDI) or mixtures of these isocyanates.

Even more preferably, the polyisocyanates are present as prepolymers, biurets, isocyanurates, iminooxadiazinediones, uretdiones and/or allophanates, which can be produced by oligomerizing difunctional isocyanates or by reacting the isocyanate compounds with polyols or polyamines, individually or as a mixture, and which have an average NCO functionality of 2 or more.

Examples of suitable, commercially available isocyanates are Desmodur® N 3900, Desmodur® N 100, Desmodur® Ultra N 3200, Desmodur® Ultra N 3300. Desmodur® Ultra N 3600, Desmodur® N 3800, Desmodur® XP 2675, Desmodur® 2714, Desmodur® 2731, Desmodur® N 3400, Desmodur® XP 2679, Desmodur® XP 2731, Desmodur® XP 2489, Desmodur® E 3370, Desmodur® XP 2599, Desmodur® XP 2617, Desmodur® XP 2406, Desmodur® XP 2551, Desmodur® XP 2838, Desmodur® XP 2840, Desmodur® VL, Desmodur® VL 50, Desmodur® VL 51, Desmodur® ultra N 3300, Desmodur® eco N 7300, Desmodur® E23, Desmodur® E XP 2727, Desmodur® E 30600, Desmodur® E 2863 XP Desmodur® H, Desmodur® VKS 20 F, Desmodur® 44V20I, Desmodur® 44P01, Desmodur® 44V70 L Desmodur® N3400, Desmodur® N3500 (all available from Covestro AG), Tolonate™ HDB, Tolonate™ HDB-LV, Tolonate™ HDT, Tolonate™ HDT-LV, Tolonate™ HDT-LV2 (available from Vencorex), Basonat® HB 100, Basonat® HI 100, Basonat® HI 2000 NG (available from BASF), Takenate® 500, Takenate® 600, Takenate® D-132N(NS), Stabio® D-378N (all available from Mitsui), Duranate® 24A-100, Duranate® TPA-100, Duranate® TPH-100 (all available from Asahi Kasai). Coronate® HXR, Coronate® HXLV, Coronate® HX, Coronate® HK (all available from Tosoh).

One or more polyisocyanates are contained in the isocyanate component preferably in a proportion of from 20 to 100 wt. %, more preferably in a proportion of from 30 to 90 wt. % and even more preferably in a proportion of from 35 to 65 wt. %, based on the total weight of the isocyanate component.

Amine Compounds

The amine component, which is provided separately from the isocyanate component in the multi-component resin system in a reaction-inhibiting manner, comprises at least one amine which is reactive to isocyanate groups and comprises an amino group, preferably at least two amino groups, as functional groups. According to the invention, the amine has an average NH functionality of 2 or more. The average NH functionality indicates the number of hydrogen atoms bonded to a nitrogen atom in the amine. Accordingly, for example, a primary monoamine has an average NH functionality of 2, a primary diamine has an average NH functionality of 4, an amine having 3 secondary amino groups has an average NH functionality of 3 and a diamine having one primary and one secondary amino group has an average NH functionality of 3. The average NH functionality can also be based on the information provided by the amine supplier, the NH functionality actually indicated possibly differing from the theoretical average NH functionality as it is understood here. The expression “average” means that it is the NH functionality of the compound and not the NH functionality of the amino group(s) contained in the compound. The amino groups can be primary or secondary amino groups. The amine can contain either only primary or only secondary amino groups, or both primary and secondary amino groups.

According to a preferred embodiment, the amine which is reactive to isocyanate groups is selected from the group consisting of aliphatic, alicyclic, araliphatic and aromatic amines, particularly preferably from the group consisting of alicyclic and aromatic amines.

Amines which are reactive to isocyanate groups are known in principle to a person skilled in the art. Examples of suitable amines which are reactive to isocyanate groups are given below, but without restricting the scope of the invention. These can be used either individually or in any mixtures with one another. Examples are: 1,2-diaminoethane(ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, norbornane diamine), dimethyl dipropylenetriamine, dimethylaminopropylaminopropylamine (DMAPAPA), 2,4-diamino-3,5-dimethylthiotoluene (dimethylthio-toluene diamine DMTDA), 3-aminomethyl-3,5,5-trimethylcyclohexyl amine (isophorone diamine (IPDA)), diaminodicyclohexylmethane (PACM), diethylmethylbenzenediamine (DETDA), 3,3′-diaminodiphenylsulfone (33 dapsone), 3,3′-diaminodiphenylsulfone (dapsone), 4,4′-diaminodiphenylsulfone (44 dapsone), 3,3′-diaminodiphenylsulfone (dapsone) mixed polycyclic amines (MPCA) (e.g. Ancamine 2168), dimethyldiaminodicyclohexylmethane (Laromin C260), 2,2-bis(4-aminocyclohexyl)propane, (3(4),8(9)bis(aminomethyldicyclo[5.2.1.0^{2.0}]decane (mixture of isomers, tricyclic primary amines; TCD diamine), methylcyclohexyl diamine (MCDA), N,N′-diaminopropyl-2-methyl-cyclohexane-1,3-diamine, N,N′-diaminopropyl-4-methyl-cyclohexane-1,3-diamine, N-(3-aminopropyl)cyclohexylamine, and 2-(2,2,6,6-tetramethylpiperidin-4-yl)propane-1,3-diamine.

Particularly preferred amines are diethylmethylbenzenediamine (DETDA), 2,4-diamino-3,5-dimethylthiotoluene (dimethylthio-toluene diamine, DMTDA), 4,4′-methylene-bis[N-(1-methylpropyl)phenylamine], an isomer mixture of 6-methy-2,4-bis(methylthio)phenylene-1,3-diamine and 2-methyl-4,6-bis(methylthio)phenylene-1,3-diamine (Ethacure® 300), 4,4′-methylenebis(2,6-diethylaniline), 4,4′-methylenebis(N-sec-butylcyclohexanamine) (Clearlink® 1000), 3,3′-diaminodiphenylsulfone (33 dapsone), 4,4′-diaminodiphenylsulfone (44 dapsone), N,N′-di-sec-butyl-p-phenylenediamine and 2,4,6-trimethyl-m-phenylenediamine, 4,4′-methylenebis(N-(1-methylpropyl)-3,3′-dimethylcyclohexanamine (Clearlink® 3000), the reaction product of 2-propenenitrile with 3-amino-1,5,5-trimethylcyclohexanemethanamine (Jefflink® 745) and 3-((3(((2-cyanoethyl)amino)methyl)-3,5,5-trimethylcyclohexyl)amino)propiononitrile (Jefflink® 136 or Baxxodur PC136).

Particularly preferred amines are 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (Ethacure 300), 4,4′-methylenebis(2,6-diethylaniline), 4,4′-methylenebis(N-sec-butylcyclohexanamine) (Clearlink 1000), 3,3′-diaminodiphenylsulfone (dapsone), N,N′-di-sec-buty-p-phenylenediamine and 2,4,6-trimethyl-m-phenylenediamine.

One or more amines are contained in the amine component preferably in a proportion of from 20 to 100 wt. %, more preferably in a proportion of from 30 to 70 wt. % and even more preferably in a proportion of from 35 to 70 wt. %, based on the total weight of the amine component.

The quantity ratios of the polyisocyanate and the amine are preferably selected such that the ratio of the average NCO functionality of the polyisocyanate to the average NH functionality of the amine is between 0.3 and 2.0, preferably between 0.5 and 1.8, more preferably between 0.5 and 1.5, even more preferably between 0.7 and 1.5 and most preferably 0.7 to 1.3.

A mixture of different isocyanates and/or different amines can be used to adjust the rate of curing. In this case, their quantity ratios are selected such that the ratio of the averaged NCO functionality of the isocyanate mixture to the averaged NH functionality of the amine mixture is between 0.3 and 2.0, preferably between 0.5 and 1.8, more preferably between 0.5 and 1.5, even more preferably between 0.7 and 1.5 and most preferably between 0.7 and 1.3.

Fillers and Additives

According to the invention, the multi-component resin system contains as an additive a compound of formula I Aₘ(L)ₘ(X)ₚ or a siloxane having at least one functional group which is capable of addition reaction to isocyanate groups, but which has no hydrolyzable groups bonded to a silicon atom. In particular no alkoxy groups.

The additive according to the invention can be present individually or as a mixture of additives.

The additives according to the invention make the use of silanes or siloxanes with silicon-bonded hydrolyzable groups superfluous or can replace the known hydrolyzable silanes and siloxane oligomers in whole or in part. Surprisingly, this leads to good and rapid curing of the chemical mortars, even at the boundary surface, despite the absence of silicon-bonded substituted groups.

With the additives according to the invention, an improvement in the performance of the mortar is possible in dry concrete for hammer-drilled and diamond-drilled boreholes, in particular for well-cleaned boreholes, in comparison with mortar compositions without corresponding additives. Fastening components using the multi-component resin system according to the invention results in high load values in dry, cleaned boreholes, which are increased compared with siloxane-free or, in some cases, silane-containing materials, without resorting to the silanes or siloxane oligomers of the prior art.

Surprisingly, it was found that improved adhesion of the cured mortar to the concrete surface and improved load values of cast-in fastening means commonly used in the construction sector, such as anchors, threaded screws and bolts, in wet and dry concrete, can be achieved even with low proportions of additives in the mortar compositions.

According to the invention, in a first alternative, the multi-component resin system contains a compound of formula I as an additive

Aₙ(L)ₘ(X)ₚ (formula I)

where
A is phosphorous, boron, aluminum, titanium or zirconium,
X can be the same or different and is an alkoxy, aryloxy or acyloxy group,
L can be the same or different and is at least one ligand,
n is the valency of A, and
p is an integer from 1 to n.
m is 0 or an integer from 1 to n−1 and
n=m+p.

The ligand L can be selected from the group consisting of acetoacetate, alkyl, halide, phosphate, pyrophosphate, phosphite, sulfate, sulfite, CN, cyclopentadienyl and pentamethylcyclopentadienyl, ethers such as tetrahydrofuran, pyridine and morpholine. The terms phosphate, pyrophosphate, phosphite, sulfate and sulfite also include their esters and half-esters with alcohols, in particular alkoxy compounds having 1 to 24 carbon atoms.

In a preferred embodiment of the compound of formula I

Aₙ(L)ₘ(X)ₚ (formula I)

X is an alkoxy group —OR¹ or an acyloxy group —O(C═O)R¹, in which R¹ is an optionally substituted, linear or branched alkyl group having 1 to 24 carbon atoms, preferably having 1 to 18 carbon atoms and particularly preferably having 1 to 8 carbon atoms.

X is particularly preferably an alkoxy or acyloxy group selected from the group consisting of —O—CH₃—, —OC₂H₅, —OC₃H₇, —OC₄H₉, —OC₅H₁₁, —O—(CO)—CH₃—, —O—(CO)—C₂H₅, —O—(CO)—C₃H₇, —O—(CO)—C₄H₉ and —O—(CO)—C₅H₁₁, preferably from the group consisting of —O—CH₂, —OC₂H₅, —OC₃H₇ and —OC₄H₉.

The group X can be the same or different. In a preferred embodiment of the invention, X is the same.

Preferably m=0 and n=p.

In a further preferred embodiment, the compound of formula I is selected from the group consisting of trimethyl phosphate, triethyl phosphate, triethyl borate, triisopropyl borate, tributyl borate, triethyl aluminate, tetraethyl titanate, tetraisopropyl titanate, tetraethyl zirconate, tetrabutyl zirconate, tris(isooctadecanoato-O)(propan-2-olato)titanate (CAS No.: 61417-49-0), isopropyl dimethacryloyl isostealoyl titanate (CAS No.: 61548-33-2), tris(dodecylbenzenesulfonate)isopropoxide titanate (CAS No.: 61417-55-8), isopropyl tri(dioctylphosphato)titanate (CAS No.: 65345-34-8), trimethacrylate methoxyethoxyethoxide titanate (CAS No.: 61436-48-4), isopropyl titanium tri(dioctylpyrophosphate) (CAS No.: 68585-78-4), isopropyl triacryloyl titanate (CAS No.: 61436-49-5), bis(2-((2-aminoethyl)amino)ethanolato)(2-((2-aminoethyl)amino)ethanolato-O)propan-2-olato)titanate (CAS No.: 65380-84-9), tetraisopropoxytitanium (CAS No.: 68585-67-1), tetraoctyl-di(ditridecylphosphite)titanate (CAS No.: 68585-68-2) and tetra(2,2-diallyloxymethyl-1-butyl)bis(ditridecylphosphite)titanate (CAS No.: 64157-14-8).

Isopropyl tri(dioctylpyrophosphate) titanate or tetraoctyl titanate bis(ditridecyl phosphite), which are available from Kenrich-Chemicals Inc., among others, are particularly suitable as complex compounds of formula I.

In a preferred embodiment, the at least one compound of formula I is present in a proportion of 0.01 to 10 wt %, more preferably in a proportion of 0.01 to 5 wt. %, even more preferably in a proportion of 0.1 to 5 wt. % and particularly preferably in a proportion of 0.1 to 3 wt. %, based on the total weight of the multi-component resin system.

According to the invention, in a second alternative, the multi-component resin system contains as an additive at least one siloxane having at least one functional group which is capable of addition reaction to isocyanate groups, but which has no hydrolyzable groups bonded to a silicon atom, in particular no alkoxy groups.

The multi-component resin system according to the invention preferably contains no siloxanes with silicon-bonded hydrolyzable groups. Silicon-bonded hydrolyzable groups are groups such as halogen atoms, ketoximate, amino, aminoxy, mercapto, acyloxy, aryloxy, aralkyloxy (=arylalkoxy) or in particular alkyloxy (alkoxy) groups which are bonded to a silicon atom via a heteroatom.

For the purposes of the present invention, siloxanes are understood as meaning chemical compounds constructed from siloxane units. In these siloxane units, the silicon atoms that cannot reach their octet (electron shell) due to the formation of bonds to oxygen are saturated with organic groups. In contrast to the (poly)silanes, the silicon atoms are not linked to one another, but to their neighboring silicon atom by exactly one oxygen atom: Si—O—Si.

A siloxane unit can have one to four further substituents, depending on the number of vacant valences on the oxygen: RₙSiO₍₄₋ₙ₎₂ (n=0, 1, 2, 3), i.e. a siloxane unit can have one to four further substituents, depending on the number of valences on the oxygen that have remained free. The siloxane units can therefore be monofunctional, difunctional, trifunctional and tetrafunctional, with the following abbreviations usually being used: [M]=R₃SiO_{1/2}, [D]=R₂SiO_{2/2}, [T]=RSiO_{3/2} and [Q]=SiO_{4/2}.

Linear (poly)siloxanes have the construction [MDₙM], corresponding to the general formula R₃Si—[O—SiR₂]ₙ—O—SiR₃, where R can be hydrogen atoms or organic groups, for example alkyl groups, and n can be 0 or an integer. An example of a linear polysiloxane is poly(dimethylsiloxane).

Branched polysiloxanes which have trifunctional or tetrafunctional siloxane units as branching elements have the construction [MₙDₘTₙ], where n and m are integers. The branching points are built into either a chain or a ring. Cyclic polysiloxanes are constructed in the form of rings from difunctional siloxane units with the construction [Dₙ], where n is an integer greater than or equal to 3. Crosslinked polysiloxanes in this group are chain or ring-shaped molecules which are linked to form planar or three-dimensional networks by means of trifunctional and tetrafunctional siloxene units.

The siloxane backbone can include various hydrocarbon groups, and silicon-bonded functional groups and organofunctional groups can be present. However, no silicon-functional groups are present in the siloxanes used according to the invention. For the purposes of the present invention, functional groups or groups therefore always mean organofunctional groups, i.e. functional groups bonded to carbon.

The siloxanes according to the invention make the use of silanes or siloxanes with silicon-bonded hydrolyzable groups superfluous or can replace the known hydrolyzable silanes and siloxanes in whole or in part. It is assumed that the siloxanes used according to the invention make the mortar surface sufficiently hydrophobic to reduce water absorption by the mortar or diffusion of curing agents such as amines into the water layer at the mortar-borehole boundary surface. Surprisingly, this leads to good curing of the chemical mortar, even at the boundary surface, despite the absence of silicon-bonded hydrolyzable groups.

In both dry and water-saturated concrete for hammer-drilled and diamond-drilled boreholes, the siloxanes according to the invention, which are free of hydrolyzable silicon-bonded groups, can improve the performance of the mortar under critical borehole conditions without the formation of undesirable VOCs. Fastening components using the two-component mortar composition according to the invention results in high load values, in particular in dry, cleaned boreholes and very particularly in very well-cleaned boreholes, which are increased compared to siloxane-free or, in some cases, silane-containing materials, without resorting to the silanes or siloxane oligomers of the prior art, which pollute the environment through the formation of VOCs.

In a preferred embodiment, the two-component mortar composition contains at least one siloxane having at least one functional terminal group which is capable of addition reaction with isocyanate groups. The siloxene more preferably comprises two or more identical or different, particularly preferably two identical terminal functional groups capable of addition reaction with isocyanate groups. The functionalization of the siloxanes according to the invention allows them to be firmly incorporated into the polymer structure and optionally also to serve as a curing agent for the resin if the functional group is, for example, an amino group.

Preferred functional groups capable of addition reaction with isocyanate groups in one of the above-mentioned embodiments of the invention are selected from the group consisting of hydroxy, carboxy, amino, sec, amino, mercapto, isocyanato, alkenyl, (meth)acryloyl, anhydrido, epoxide, urethane and urea groups, preferably from the group consisting of isocyanato and amino groups.

In a further preferred embodiment of the two-component mortar composition according to the invention, the siloxane has the structure R₃Si—[O—Si(R¹)₂]ₙO—SiR₃, where n is 0 or an integer from 1 to 1000, inclusive, preferably 0 or 1 to 5; and R and R¹, independently of one another, are in each case an optionally substituted C₁-C₂₀ alkyl group or aralkyl group optionally containing heteroatoms and optionally comprising at least one group capable of addition reaction with isocyanate groups, R¹ is preferably an unsubstituted C₁-C₄ alkyl group, in particular a methyl group.

The heteroatoms are preferably oxygen atoms. The groups R and R¹ are each bonded to silicon via a carbon atom.

In this embodiment, the siloxane preferably comprises one and more preferably two or more substituted C₁-C₂₀alkyl or aralkyl groups, the substituents being selected from the group consisting of trialkylsilyl (e.g. trimethylsilyl), hydroxy, carboxy, amino, sec, amino, mercapto, isocyanato, alkenyl, (meth)acryloyl, anhydrido and epoxy groups, preferably from the group consisting of isocyanato, (meth)acryloyl, trimethylsilyl and amino groups and particularly preferably from the group consisting of isocyanato and amino groups.

In particular, the siloxanes are selected from the group consisting of 1,3-bis(2-aminoethylaminoethyl)tetramethyldisiloxane, 1,3-bis(glycidoxypropyl)tetramethykiisiloxane, tris(glycidoxypropyldimethylsiloxy)phenylsilane, 3-methacryloxypropylpentamethyldisiloxane, poly(acryloxypropylmethyl)siloxane, 1,3-bis[(acryloxypropylmethyl)siloxane, 1,3-bis(3-methacryloxypropyl)tetrakis-(trimethylsiloxy)disiloxane, 1,3-bis(3-methacryloxypropyl)tetramethyldisiloxane, monomethacryloxypropyl terminated polydimethylsiloxane, poly[dimethylsiloxane-co-(3-(monomethacryloxy)propyl)methylsiloxane], 1,3,-bis(4-methacryloxybutyl)tetramethyldisiloxane, (methacryloxypropyl)methylsiloxane/dimethylsiloxane copolymer, dodecamethylpentasiloxane, 1,1,1,3,5,7,7,7-octamethyl-3,5-bis(trimethylsilanyloxy)tetrasiloxane, trimethylsilyl-terminated poly(methylhydro-siloxane), bis(hydroxyalkyl)-terminated poly(dimethylsiloxane), poly[dimethylsiloxane-co-(2-(3,4-epoxycyclohexyl)ethyl)methylsiloxane], diglycidyl ether terminated poly(dimethylsiloxane), poly[dimethylsiloxane-co-[3-(2-(3-hydroxy-oxy)ethoxy)propyl]methylsiloxane and monoglycidyl ether terminated poly(dimethylsiloxane), and mixtures thereof.

Particularly preferred examples are 1,3-bis(2-aminoethylaminoethyl)tetramethyldisiloxane, 1,3-bis(glycidoxypropyl)tetramethyldisiloxane and tris(glycidoxypropyldimethylsiloxy)phenylsilane, and mixtures thereof.

The siloxanes used according to the invention can be present individually or as a mixture and, based on the total multi-component resin system, in a weight proportion of from 0.5 to 10 wt. %, preferably from 0.5 to 8 wt. % and more preferably from 1.5 to 5 wt. %.

Both the isocyanate component and the amine component can contain at least one filler and at least one rheology additive. It being essential to the invention that at least one of the two components contains both a filler and a rheology additive. It is preferable for both the isocyanate component and the amine component to each contain at least one filler and at least one rheology additive.

The total filling level of a mortar composition produced by mixing the isocyanate component and the amine component of the multi-component resin system is, according to the invention, in a range from 30 to 80 wt. %, based on the total weight of the mortar composition, preferably in a range from 35 to 65 wt. %, more preferably in a range from 35 to 60 wt. %. The total filling level of the mortar composition relates to the percentage by weight of filler and rheology additive based on the total weight of the isocyanate component and the amine component. In a preferred embodiment, the filling level of the isocyanate component is up to 80 wt. %, preferably from 10 to 70 wt. %, more preferably from 35 to 85 wt. %, based on the total weight of the isocyanate component. The filling level of the amine component is preferably up to 80 wt. %, more preferably from 10 to 70 wt. %, even more preferably from 35 to 65 wt. %, based in each case on the total weight of the amine component.

Inorganic fillers, in particular cements such as Portland cement or aluminate cement and other hydraulically setting inorganic substances, quartz, glass, corundum, porcelain, earthenware, barite, light spar, gypsum, talc and/or chalk and mixtures thereof are preferably used as fillers. The inorganic fillers can be added in the form of sands, powders, or molded bodies, preferably in the form of fibers or balls. A suitable selection of the fillers with regard to type and particle size distribution/(fiber) length can be used to control properties relevant to the application, such as rheological behavior, press-out forces, internal strength, tensile strength, pull-out forces and impact strength. Particularly suitable fillers are quartz powders, fine quartz powders and ultra-fine quartz powders that have not been surface-treated, such as Millisil® W3, Millisil® W6. Millisil® W8 and Millisil® W12, preferably Millisil® W12. Silanized quartz powders, fine quartz powders and ultra-fine quartz powders can also be used. These are commercially available, for example, from the Silbond® product series from Quarzwerke. The product series Silbond® EST (modified with epoxysilane) and Silbond® AST (treated with aminosilane) are particularly preferred. Furthermore, it is possible for fillers based on aluminum oxide such as aluminum oxide ultra-fine fillers of the ASFP type from Denka, Japan (d50=0.3 μm) or grades such as DAW or DAM with the type designations 45 (d50<0.44 μm), 07 (d50>8.4 μm), 05 (d50<5.5 μm) and 03 (d50<4.1 μm). Moreover, the surface-treated fine end ultra-fine fillers of the Aktisil AM type (treated with aminosilane, d50=2.2 μm) and Aktisil EM (treated with epoxysilane, d50=2.2 μm) from Hoffman Mineral can be used. The fillers can be used individually or in any mixture with one another.

The flow properties are adjusted by adding rheology additives which, according to the invention, are used in the isocyanate component and/or the amine component. Suitable rheology additives are: phyllosilicates such as laponites, bentones or montmorillonite. Neuburg siliceous earth, fumed silicas, polysaccharides; polyacrylate, polyurethane or polyurea thickeners and cellulose esters. Wetting agents and dispersants, surface additives, defoamers & deaerators, wax additives, adhesion promoters, viscosity reducers or process additives can also be added for optimization.

The proportion of one or more rheology additives in the isocyanate component is preferably from 0.1 to 3 wt. %, more preferably from 0.1 to 1.5 wt. %, based on the total weight of the isocyanate component. The proportion of one or more rheology additives in the amine component is preferably from 0.1 to 5 wt. %, more preferably from 0.5 to 3 wt. %, based on the total weight of the amine component.

In one embodiment, the multi-component resin system contains a molecular sieve, in particular a zeolite as a filler.

Synthetic or natural zeolites, which are generally characterized by the composition Mn⁺_{x/n}[(AlO₂)·ₓ(SiO₂)_{y}]·_{z}H₂O, where n is the charge of M, usually 1 or 2, and M is a cation of an alkali or alkaline earth metal, in particular Na⁺, K⁺, Ca²⁺, and Mg²⁺, can be used as zeolites.

The following can be used as zeolites:
zeolite A (Na₁₂[(AlO₂)12(SiO₈)₁₂]·27H₂O; K₁₂[(AlO₂)₁₂(SiO₂)₁₂]·27H₂O),
zeolite X (Na₈₆[(AlO₂)₈₆(SiO₂)₁₀₆]·264H₂O),
zeolite Y (Nₐ₅₆[(AlO₂)₅₆(SiO₂)₁₃₆]·250H₂O).
zeolite L (K₉[(AlO₂)₉(SiO₂)₂₇]·22H₂O),
mordenite (Na_{8.7}[(AlO₂)_{8.7}(SiO₂)_{38.3}]·24H₂O),
zeolite ZSM 5 (Na_{0.3}H_{3.8}[(AlO₂)_{4.1}(SiO₂)_{91.9}]) and
zeolite ZSM 11 (Na_{8.1}H_{1.7}[(AlO₂)_{1.8}(SiO₂)_{91.2}]).

Of these, zeolite A, zeolite X, zeolite Y and zeolite ZSM 5 and zeolite ZSM 11 are preferred.

The molecular sieve, in particular the zeolite, can be used as a powder, granular material or as a paste (for example 48-50% powder dispersed in castor oil).

The synthetic zeolite is preferably a synthetic zeolite comprising particles having a particle size of up to 250 μm, in particular from 5 μm to 24 μm. The synthetic zeolite particularly preferably has a pore size of approximately 5 Å to approximately 10 Å, in particular approximately 3 Å to approximately 4 Å.

The specific surface area (BET) of the zeolite particles is preferably between 800 m²/g and 1000 m²/g.

The residual water content of the zeolite is below 2.5% w/w, preferably below 1.5% w/w, and the water absorption capacity is below 22-24% w/w.

It is possible to use a mixture of two or more different types of zeolite.

The molecular sieve, in particular the zeolite, is preferably used in an amount of from 0.1 to 60 wt. %, particularly preferably in an amount of from 1 to 35 wt. % and very particularly preferably in an amount of from 2 to 5 wt. %, based on the total weight of the multi-component resin system. The amounts are taken into account in the general, above-mentioned amounts for the fillers, the amounts for the molecular sieve being taken into account in the amounts of fillers.

The molecular sieve can be contained in one of the two components of the multi-component resin system or In both components.

The invention also relates to a mortar composition which is produced by mixing the isocyanate component and the amine component of the multi-component resin system.

The multi-component resin system is preferably present in cartridges or film pouches which are characterized in that they comprise two or more separate chambers in which the isocyanate component and the amine component are separately arranged in a reaction-inhibiting manner.

For the use as intended of the multi-component resin system, the isocyanate component and the amine component are discharged out of the separate chambers and mixed in a suitable device, for example a static mixer or dissolver. The mixture of isocyanate component and amine component (mortar composition) is then introduced into the previously cleaned borehole by means of a known injection device. The component to be fastened is then inserted into the mortar composition and aligned. The reactive constituents of the isocyanate component react with the amino groups of the amine component by polyaddition such that the mortar composition cures under environmental conditions within a desired period of time, preferably within a few minutes or hours.

The mortar composition according to the invention or the multi-component resin system according to the invention is preferably used for construction purposes. The expression “for construction purposes” refers to the structural adhesion of concrete/concrete, steel/concrete or steel/steel or one of said materials with other mineral materials, to the structural strengthening of components made of concrete, brickwork and other mineral materials, to reinforcement applications with fiber-reinforced polymers of building objects, to the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the mortar compositions according to the invention and the multi-component resin systems according to the invention are used for the chemical fastening of anchoring means.

The present invention also relates to a method for the chemical fastening of construction elements in boreholes, a mortar composition according to the invention or a multi-component resin system according to the invention being used as described above for the chemical fastening of the construction elements. The method according to the invention is particularly suitable for the structural adhesion of concrete/concrete, steel/concrete or steel/steel or one of said materials with other mineral materials, for the structural strengthening of components made of concrete, brickwork and other mineral materials, for reinforcement applications with fiber-reinforced polymers of building objects, for the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the method according to the invention is used for the chemical fastening of anchoring means.

The present invention also relates to the use of a mortar composition according to the invention or a multi-component resin system for the chemical fastening of construction elements in mineral substrates.

The invention also relates to the use of a mortar composition according to the invention or a multi-component resin system according to the invention for improving the pull-out strength of a chemical anchor produced from a multi-component resin system according to the invention boreholes. This includes in particular an increase in pull-out strengths in well-cleaned boreholes, well-cleaned meaning that the boreholes are repeatedly blown out with compressed air, then brushed out in order to loosen bore dust and cuttings adhering to the borehole wall, and then repeatedly blown out again with compressed air.

The invention is described in greater detail below on the basis of examples which, however, should not be understood in a restrictive sense.

### EMBODIMENTS

The following compounds were used to prepare the comparative composition and the composition according to the invention:

| | | |
|---|---|---|
| Hexamethylene-1,6-diisocyanate | low-viscosity, aliphatic polyisocyanate resin | Covestro AG |
| homopolymers | based on hexamethylene diisocyanate | |
| | (equivalent weight approx. 17 [symbol] NCO content | |
| | according to M105-ISO 11909 23.5 ± | |
| | 0.5 wt % [symbol] according to | |
| | M10 [symbol] -ISO 102 [symbol] 3 < 0.25%; viscosity (23° C.) | |
| | M014-ISO 3219 [symbol] 730 [symbol] 100 mPa · s; | |
| | Desmodur ™ N 3900) | |
| Mixture of [symbol] -methyl-2,4- | Ethacure ® 300 Curative (dimethylthiotoluene | Alb [symbol] Corporation |
| bis(methylthio)phenylene-1,3-diamine and | diamine 95-97%, monomethylthiotoluene | |
| 2-methyl-4,6-bis(methylthio)phenylene- | diamine 2-3%, equivalent weight with | |
| 1,3-diamine | ( [symbol] 107) | |
| 3-glycidyloxypropyltrimethoxysilane | Dynasylan ® GLYMO | Evonik Resource |
| | | Efficiancy GmbH |
| Tris(isooctadecanoate-O)(propan-2- | Ken-React ® KR ® TTS | FARRL GmbH |
| olato)titanium | | |
| Hydrogen tetrakis[2,2- | Ken-React ® KR ® 55 | FARRL GmbH |
| bis(allyloxy)methyl]butane-1-olato- | | |
| O [symbol] bis(ditridecyl phosphilo-O [symbol] )titanate(2 [symbol] ) | | |
| 1,3- | | ABCR GmbH |
| bis(glycidyloxypropyl)tetramethyldisiloxane | | |
| Quartz powder | Millisil ™ W12 | Quarzwork [symbol] |
| Silica | Cab-O-Sil ™ TS- 720 | Cabot |

[symbol]

indicates data missing or illegible when filed

The comparative composition and the compositions according to the invention of the isocyanate component and the amine component are shown in Table 1 below.

TABLE 1
Compositions of the isocyanate component and the
amine component [wt. %] for the comparative example
and examples 1 to 4 according to the invention; use of
different additives.

| | | | Comparison | Comparison | | | |
|---|---|---|---|---|---|---|---|
| | | | 1 | 2 | 1 | 2 | 3 |
| Isocyanate | Hexamethylene-1,5-diisocyanate | | 37.5 | 36 | 37.5 | 37.5 | 36 |
| component | homopolymer (Desmodur ® N3900) | | | | | | |
| | Additive | 3-glycidyloxypropyltrimethoxysilane | | 3 | | | |
| | | Dynaslan ® Glymo | | | | | |
| | | Tris(isooctadecancato-O)(propan-2- | | | 0.5 | | |
| | | olato)titanium (Ken-React ® KR ® TTS) | | | | | |
| | | Hydrogen tetrakis[2,2- | | | | 0.5 | |
| | | bis(allyloxy)methyl]butane-1-olato- | | | | | |
| | | O1]bis(ditridecyl phosphito- | | | | | |
| | | O [symbol] )titanate(2-) (Ken-React ® KR ® 55) | | | | | |
| | | 1,3- | | | | | 3 |
| | | bis(glycidoxypropyl)tetramethyldisiloxane | | | | | |

| | | | | | | |
|---|---|---|---|---|---|---|
| | Quartz powder (W12) | 52 | 50.5 | 51.5 | 51.5 | 50.5 |
| | Silica | 1.5 | 1.5 | 1.5 | 1.5 | 1.5 |
| | Zeolite (Pumol 3ST Powder) | 3 | 3 | 3 | 3 | 3 |
| Amine | (6-methyl-2,4-bis(methylthio)phenylene-1,3- | 49.5 | 49.5 | 49.5 | 49.5 | 49.5 |
| component | diamine (2-methyl-4,6- | | | | | |
| | tris(methylthio)phenylene-1,3-diamine | | | | | |
| | (DMTDA) | | | | | |
| | Quartz powder (W12) | 49 | 49 | 49 | 49 | 49 |
| | Silica | 1.5 | 1.5 | 1.5 | 1.5 | 1.5 |

[symbol]

indicates data missing or illegible when filed

To produce the mortar compositions, the isocyanate component and the amine component were each first produced individually. For this purpose, the constituents indicated in Table 1 were homogenized in a dissolver (PC Laborsystem GmbH, 8 min; 3500 rpm) under vacuum (80 mbar) to form an sir-bubble-tree pasty composition. The isocyanate component and the amine component were then combined with one another and mixed in a speed mixer for 30 seconds at 1500 rpm. The mortar composition obtained in this way was filled into a single-component hard cartridge and injected into a borehole using an extrusion device.

In order to determine the bond stresses (load values) of the cured fastening compositions, anchor threaded rods Hilti HAS-M12 were inserted into hammer-bored boreholes in C20/25 dry concrete having a diameter of 14 mm and a borehole depth of 72 mm. Here, the boreholes were first cleaned twice with compressed air (6 bar), then twice with a cleaning brush and then again twice with compressed air (6 bar). The boreholes cleaned in this way were then filed halfway with the comparative composition and the compositions according to the invention, and the anchor threaded rods were inserted to an embedding depth of 60 mm. The bond stresses were determined by centrally pulling out the anchor threaded rods. In each case, five anchor threaded rods were inserted and, after 24 hours of curing at approximately 21° C., the bond stress was determined. The fastening compositions were ejected out of the cartridges via a static mixer (HIRT-RE-M mixer; Hilti Aktiengesellschaft) and injected into the boreholes.

The bond stresses obtained using the mortar formulations described above for dry and well-cleaned boreholes are listed in Table 2 below.

TABLE 2
Results of the determination of the bond stresses

| | Comparison | Comparison | | | |
|---|---|---|---|---|---|
| | 1 | 2 | 1 | 2 | 3 |
| Bond stress [N/mm²] | 28.8 | 33.2 | 31.1 | 33 | 32.7 |

The results show that the compositions according to the invention have a higher performance in well-cleaned, dry boreholes compared with compositions containing no adhesion promoter. Furthermore, the results show that the claimed additives show comparable values to the silane additives of comparative example 2.

1: A multi-component resin system, containing:
an isocyanate component comprising at least one aliphatic and/or aromatic polyisocyanate having an average NCO functionality of 2 or more, and
an amine component comprising at least one amine which is reactive to isocyanate groups and has an average NH functionality of 2 or more,
with the proviso that the multi-component resin system is free of polyaspartic acid esters, the isocyanate component and/or the amine component comprising at least one filler and at least one rheology additive, and total filling level of a mortar composition produced by mixing the isocyanate component and the amine component is in a range from 30 to 80 wt. %,
wherein the isocyanate component and/or the amine component contains at least one additive, the at least one additive being
a compound of formula I
Aₙ(L)ₘ(X)ₚ (formula I),
wherein
A is phosphorous, boron, aluminum, titanium, or zirconium,
X can be the same or different and is an alkoxy, aryloxy, or acyloxy group,
L can be the same or different and is at least one ligand,
n is the valency of A,
p is an integer from 1 to n,
m is 0 or an integer from 1 to n−1, and
n=m+p,
or
a siloxane having at least one functional group which is capable of addition reaction to isocyanates, but which has no hydrolyzable groups bonded to a silicon atom.

2: The multi-component resin system according to claim 1, wherein in the compound of formula I, X is an alkoxy group —OR¹ or an acyloxy group —O(C═O)R¹, where R¹ is in each case an optionally substituted, linear or branched alkyl group having 1 to 24 carbon atoms.

3: The multi-component resin system according to claim 2, wherein X is a group selected from the group consisting of —O—CH₃—, —OC₂H₅, —OC₃H₇, —OC₄H₉, —OC₅H₁₁, —O—(CO)—CH₃—, —O—(CO)—C₂H₅, —O—(CO)—C₃H₇, —O—(CO)—C₄H₉, and —O—(CO)—C₅H₁₁.

4: The multi-component resin system according to claim 3, wherein X is a group selected from the group consisting of —O—CH₃, —OC₂H₅, —OC₃H₇, and —OC₄H₉.

5: The multi-component resin system according to claim 1, wherein in the compound of formula I, X is the same.

6: The multi-component resin system according to claim 1, wherein in the compound of formula I, the ligand L is selected from the group consisting of acetoacetate, phosphate, phosphite, sulfate, sulfite, CO, CN, cyclopentyl, and pentamethylcyclopentyl.

7: The multi-component resin system according to claim 1, wherein the compound of formula I is selected from the group consisting of trimethyl phosphate, triethyl phosphate, triethyl borate, triethyl aluminate, triisopropyl borate, tributyl borate, tetraethyl titanate, tetraisopropyl titanate, tetraethyl zirconate, and tetrabutyl zirconate.

8: The multi-component resin system according to claim 1, wherein the compound of formula I is present in an amount of 0.001-10 wt. %, based on a total weight of the multi-component resin system.

9: The multi-component resin system according to claim 1, wherein in the siloxane, the at least one functional group capable of addition reaction with isocyanate groups is a terminal group.

10: The multi-component resin system according to claim 9, wherein the at least one functional group is selected from the group consisting of hydroxy, carboxy, amino, sec, amino, mercapto, isocyanato, alkenyl, (meth)acryloyl, anhydride, and epoxy groups.

11: The multi-component resin system according to claim 1, wherein the siloxane has the structure
R₃Si—[O—Si(R¹)₂]ₙ—O—SiR₃
wherein
n is 0 or an integer from 1 to 1000, inclusive, and
R and R¹, independently of one another, are in each case a C₁-C₂₀-alkyl group or an aralkyl group optionally containing heteroatoms and optionally comprising at least one group capable of addition reaction with isocyanate groups.

12. (canceled)

13: The multi-component resin system according to claim 1, wherein the siloxane is selected from the group consisting of 1,3-bis(2-aminoethylaminoethyl)tetramethyldisiloxane, 1,3-bis(glycidoxypropyl)tetramethyldisiloxane, tris(glycidoxypropyldimethylsiloxy)-phenylsilane, 3-methacryloxypropylpentamethyldisiloxane, poly(acryloxypropylmethyl)siloxane, 1,3-bis[(acryloxypropylmethyl)siloxane, 1,3-bis(3-methacryloxypropyl)tetrakis-(trimethylsiloxy)disiloxane, 1,3-bis(3-methacryloxypropyl)tetramethyldisiloxane, monomethacryloxypropyl terminated polydimethylsiloxane, poly[dimethylsiloxane-co-(3-(monomethacryloxy)propyl)methylsiloxane], 1,3,-bis(4-methacryloxybutyl)tetramethyldisiloxane, (methacryloxypropyl)methyl siloxane/dimethylsiloxane copolymer, dodecamethylpentasiloxane, 1,1,1,3,5,7,7,7-octamethyl-3,5-bis(trimethylsilanyloxy)tetrasiloxane, trimethylsilyl terminated poly(methylhydro-siloxane), bis(hydroxyalkyl)-terminated poly(dimethylsiloxane), poly[dimethylsiloxane-co-(2-(3,4-epoxycyclohexyl)ethyl)methylsiloxane], diglycidyl ether terminated poly(dimethylsiloxane) poly[dimethylsiloxane-co-[3-(2-(3-hydroxy-ethoxy)ethoxy)propyl]methylsiloxane, and monoglycidyl ether terminated poly(dimethylsiloxane).

14: The multi-component resin system according to claim 1, wherein a proportion of the siloxane is from 0.5 to 20 wt. %, based on a total weight of the multi-component resin system.

15-17. (canceled)

18: The multi-component resin system according to claim 1, wherein the isocyanate component comprises at least one aromatic polyisocyanate selected from the group consisting of 1,4-phenylene diisocyanate, 2,4- and/or 2,6-toluylene diisocyanate, xylylene diisocyanate, hydrogenated xylylene diisocyanate, tetramethylxylylene diisocyanate, 1,5-naphthylene diisocyanate, diphenylene methane-2,4′- and/or -4,4′-diisocyanate, triphenylmethane-4,4′,4″-triisocyanate, bis- and tris-(isocyanatoalkyl)-benzene, toluene, xylene, and mixtures thereof.

19: The multi-component resin system according to claim 1, wherein the isocyanate component comprises at least one aliphatic polyisocyanate selected from the group consisting of hexamethylene diisocyanate (HDI), trimethyl HDI (TMDI), pentane diisocyanate (PD1), 2-methylpentane-1,5-diisocyanate (MPDI), isophorone diisocyanate (IPDI) 1,3- and 1,4-bis(isocyanatomethyl)cyclohexane (H₆XDI), bis(isocyanatomethyl)norbornane (NBDI), 3(4)-isocyanatomethyl-1-methyl-cyclohexyl isocyanate(IMCI), 4,4′-bis(isocyanatocyclohexyl)methane (H₁₂MDI), and mixtures thereof.

20: The multi-component resin system according to claim 1, wherein the total filling level is in a range from 35 to 65 wt. %, based on a total weight of the multi-component resin system.

21-22. (canceled)

23: A mortar composition, produced by mixing the isocyanate component and the amine component of the multi-component resin system according to claim 1.

24: A method for chemical fastening of a construction element in a borehole, the method comprising:
curing the multi-component resin system according to claim 1 in the borehole, to chemically fasten the construction element.

25: A method for improving pull-out values of a chemical anchor, the method comprising:
curing the multi-component resin system according to claim 1.

26: The method according to claim 25, wherein the method improves the pull-out strength of the chemical anchor in cleaned boreholes.
